(19) United States
(12) Patent Application Publication
(10) Pub. No.: US 2017/0096838 A1
(43) Pub. Date: Apr. 6, 2017

(54) DUAL INPUT LOCK WITH REMOVABLE DIAL

(71) Applicant: Klaus W. Gartner, Palos Verdes Estates, CA (US)

(72) Inventor: Klaus W. Gartner, Palos Verdes Estates, CA (US)

(21) Appl. No.: 14/876,312

(22) Filed: Oct. 6, 2015

Related U.S. Application Data
(63) Continuation of application No. PCT/US2015/053671, filed on Oct. 2, 2015.

(51) Int. Cl. E05B 37/08; E05B 65/00; E05B 49/00; E05B 47/00

(52) U.S. Cl. CPC E05B 37/08; E05B 47/0001; E05B 65/0075; E05B 49/00

(57) ABSTRACT

A lock including a removable dial is provided. The lock includes locking means configured to lock and unlock a removable dial to replace the dial or to service the lock. The locking means are moveable between a first locked position and a second unlocked position in which the dial may be removed. The locking means may comprise a finger-actuated button that is biased in the locked position by compression means. The compression means may comprise a spring. Applying force to the button overcomes the counterforce being exerted by the compression means and the front facing dial can be easily removed. To replace the dial, force must again be applied to the locking means to move the locking means to the second unlocked position or alternatively the shaft of the dial is inserted into the housing and “snaps” into place.

### CROSS-REFERENCE TO RELATED APPLICATIONS

This application is a continuation of International patent application Serial No.: PCT/US2015/053671, filed on Oct. 2, 2015; the entirety of which is hereby incorporated by reference.

### FIELD OF THE INVENTION

The present invention relates generally to an electromechanical combination lock with a dual input dial for entering a combination. In particular the invention relates to a lock that can be opened by either electronic or manual means and includes a removable dial.

### BACKGROUND OF THE INVENTION

Safes and other secure containers have traditionally used combination locks for controlling and authorizing entry. Early locks were entirely mechanical and relied on a person dialing a correct combination on a rotating dial. The rotation positioned mechanical elements within the lock such that dialing the correct combination allowed a locking bolt to release the container door. Proper dial rotation aligned gates in tumblers. Once the gates were aligned, a fence on a fence lever entered the aligned gates. Continued rotation of the dial and tumblers pulled the fence lever and withdrew the bolt.

However, over the years electromechanical locks have gradually replaced the mechanical locks described above. Indeed, electromechanical locks themselves have seen many improvements over the years. The use of sophisticated electronic logic circuitry has enabled the implementation of a series of complex and unique electronic combinations which has made improper entry into secured areas more difficult. When the lock is used to secure entry to a container, the electronic components are typically mounted within a housing inside the container door. The housing contains an actuating device and a circuit board. The electronic key pad transmits a signal to the circuit board, which contains the electronic circuitry that allows the lock to open and close. The keypad is located on the outside of the housing so as to be accessible to the user. A cable typically extends between the keypad and the circuit board for transmitting signals between the two components.

In addition to the electronic circuitry, electromechanical locks include a bolt. The bolt is movably constructed and is coupled to a bolt-displacing device enabling a user to selectively move the bolt into one of at least two end positions by means of the actuating device. The lock is blocked and therefore “locked” in a first end position of the bolt and unblocked or “open” and “unlocked” in a second end position of the bolt. When the user enters the correct combination into the electronic keypad, a signal is transmitted to the circuit board. The circuit board in turn actuates the actuating device, which allows the locking bolt to move to the unlocked position within the housing, thus allowing the user to open the safe door.

Although known electronic locks have proven effective in everyday practical use, there is a need for improvement, particularly with regard to design. For example, if the lock needs to be serviced the entire lock must be removed from the container door in order to service it. The resultant cost could be significant in light of the labor required to remove the lock from the container door. In addition, some users prefer a metal dial to a plastic dial and vice versa.

Accordingly, there is a need for a combination mechanical and electronic lock that is simple to assemble, cost efficient, can reliably block access to a container by unauthorized users and has means for allowing easy servicing of the lock and/or means for easily changing the dial.

### BRIEF SUMMARY OF THE INVENTION

The problems outlined above are addressed by the electromechanical combination lock with removable dial in accordance with the invention. The electromechanical combination lock in accordance with the invention provides for a manual mechanical means and an electronic means for opening the lock. The manual mechanical means and the electronic means are mounted on a dial, which is mounted outside the container to be protected.

The dial includes a top-reading electronic key pad configured to be disposed with a recessed portion of the dial housing. When the top-reading electronic keypad is coupled to a container to be secured, the keypad may be positioned to face upward in a generally horizontal plane relative to the container door, which is in a generally vertical plane, such that a user standing next to the container door 14 is able to look down toward the dial housing and easily view and have access to the keypad. Alternatively, if the dial is coupled to the container door in a position that is higher than eye level a user can still view the numbers on the key pad due to the angled positioning of the keypad into the recessed portion. The key pad includes a series of electronic numbers, typically from 1-9 and 0 which, when contacted by a user entering the correct combination, will generate an electronic signal to rotary means. The rotary means, which may be a solenoid, is coupled to an armature post having a first blocking member in blocking contact with a locking bolt. The armature post also includes a second outwardly extending armature post member described in detail below. Upon receiving the electronic signal the solenoid causes the armature post to rotate to an unlocked position that enables the locking bolt to by-pass the blocking member allowing the authorized user to open the lock.

The manual mode of opening of the lock includes a dial-operated plurality of tumbler wheels having gates to receive a fence member of a bolt operating release mechanism when the manual combination is correctly dialed.

A bolt operating release mechanism has three components assembled as one unit which interacts with the dial and tumblers above, and a dial operated cam. The bolt operating lever includes a nose portion at a first end that engagingly meshes with the cam and an opposite second end pivotally attached to a housing. The second end includes an outwardly extending engagement lever that contacts the second outwardly extending member on the armature post.

Upon entry of the correct manual combination, the nose portion engages the cam causing the second end of the bolt operating lever to pivot causing the outwardly extending engagement lever to push against the second outwardly extending member on the armature post in turn causing the armature post to rotate. As the armature post rotates the first block member moves to the unlocked position which allows the locking bolt to move to the unlocked position.

In one aspect of the invention a lock including a housing having an opening for receiving a locking bolt being movable between a locked position and an unlocked position is provided. The lock includes a dual input dial having an electronic digital keypad for electronic entry of a combination and a mechanical dial for manual entry of a combination; a rotary actuator positioned within the housing and energizable between a locked condition for maintaining the locking bolt in the locked position and an unlocked condition that allows the locking bolt to move to the unlocked position; a cam wheel operably coupled to the housing, the cam wheel including a cam way; a bolt release lever moveably coupled to the housing, the bolt release lever having a nose portion engageable with said cam way and a locking bar; and an armature post operably coupled to the rotary actuator, said armature post including first and second outwardly extending flanges, said first outwardly extending flange normally biased in a blocking position to block said locking bolt from being moved to the unlocked position,

Upon actuation, the rotary actuator causes the armature post to rotate by a predetermined amount in which the first outwardly extending flange rotatably moves from the blocking position to an unblocking position allowing the locking bolt to move into the unlocked position. Additionally, when the nose portion engages said cam way the locking bar moves downward by a predetermined amount to rotatably move the second outwardly extending flange and cause the first outwardly extending flange to move from the blocking position to an unblocking position allowing the locking bolt to move into the unlocked position.

In another aspect of the invention, a lock including a housing having a cavity with first and second opposing side walls and an opening for receiving a locking bolt, the locking bolt moveable between a locked position and an unlocked position is provided. The lock also includes a rotary actuator having a rotary output of a predetermined amount and responsive to entry of an electronic combination input by a user; a cam wheel operably coupled to the housing and responsive to a manual combination input of the user, the cam wheel including a cam way; a bolt release lever moveably coupled to the housing, the bolt release lever including a nose portion engageable with the cam way and a locking bar; and an armature post responsive to both of the rotary output and the manual input, the armature post moveable between a blocking position for blocking the locking bolt in the locked position and an unblocking position for allowing the locking bolt to move into the unlocked position.

The armature post in accordance with the invention includes a first blocking member responsive to the rotary output for blocking the locking bolt in the locked position and a second outwardly extending flange member rotatably responsive to a downward movement of the bolt release lever to cause the first blocking member to move to the unblocking position.

In another aspect of the invention locking means are provided to lock and unlock a removable dial. To replace the dial or to service the lock, locking means are provided inside the lock housing. The locking means are moveable between a first locked position and a second unlocked position in which the dial may be removed. The locking means may comprise a finger-actuated button that is biased in the locked position by compression means. The compression means may comprise a spring. Applying force to the button overcomes the counterforce being exerted by the spring and the front facing dial can be easily removed. To replace the dial, force must again be applied to the locking means to move the locking means to the second unlocked position or alternatively the shaft of the dial is inserted into the housing and “snaps” into place.

In another aspect of the invention a lock having a removable dial is provided. The lock includes a housing; a removable dial including a shaft receivable by the housing; a button slidably received within the housing, the button moveable between a first position and a second position; and compression means operably coupled to the button for biasing the button in the first position.

### BRIEF DESCRIPTION OF THE DRAWINGS

For a better understanding of the invention, and to show how the same may be carried into effect, reference will now be made, by way of example, to the accompanying drawings, in which:

FIG. 1 is an exploded view of the lock in accordance with the invention showing the face plate and housing.

FIG. 2 is an exemplary dial in accordance with the invention having both manual and electronic components.

FIG. 3 is a side view of the dial of FIG. 1 showing a dial shaft that engages the lock on an opposite side of a container to be secured.

FIG. 4 is a top view of the lock in accordance with the invention showing the lock in the locked position.

FIG. 5 is a top view of the lock in accordance with the invention showing the blocking member being rotated to disengage the locking bolt.

FIG. 6 is a top view of the lock in accordance with the invention showing the locking bolt in the unlocked position.

FIG. 7 is a top view illustrating the mechanical mode and showing the back wheel with corresponding gate rotated to the open position.

FIG. 8 is a top view showing the nose portion in engagement with the cam while back lever contacts and commences to cause the armature post to rotate such that the blocking member disengages from the locking bolt.

FIG. 9 is a top view showing the mechanical mode in the full open position with the locking bolt retracted.

FIG. 10 is a top view showing one alternative for biasing the locking bolt in the locked position.

FIG. 11 is a perspective view of the electromechanical lock with dual input dial in accordance with the invention.

FIG. 12 is the electromechanical lock with dual input dial of FIG. 1 illustrating the removable dial.

FIG. 13 is a side illustration of the pressable button shown in the locked position.

FIG. 14 is perspective showing the pressable button in the locked position.

FIG. 15 is a cutaway view of the back side of the housing showing the locking means biased in the locked position.

FIG. 16 is a side view of the locking means in the second, unlocked, position.

FIG. 17 is a perspective view of the locking means in the second, unlocked, position.

FIG. 18 is a cutaway view of the back side of the housing showing the locking means in the second, unlocked, position.

### DETAILED DESCRIPTION OF THE INVENTION

Swing bolt or rotary bolt locking devices mount a bolt for pivoting between locked and unlocked positions. This application refers to the swing bolt within the locking device as the “bolt,” “swing bolt,” or “locking bolt.” The bolts that secure the safe door to the rest of the safe are called “safe bolts.” In the locked position, part of the locking bolt projects out of the housing and interferes with a portion of the mechanical bolt works, thereby preventing the bolt works from moving the safe bolts to the unlocked position. When the user enters the correct combination, the lock mechanism allows the locking bolt to pivot to the unlocked position within the housing.

In general, a handle on the outside of the safe connects to the bolt works. Rotating the handle initiates movement of the bolt works. If the user enters the correct combination which unlocks or releases the locking bolt, as noted above, the bolt works can pivot the rotary bolt so that the rotary bolt does not project from the housing. This unlocked position permits the bolt works to continue moving the safe bolts to the unlocked condition, allowing the operator to open the safe.

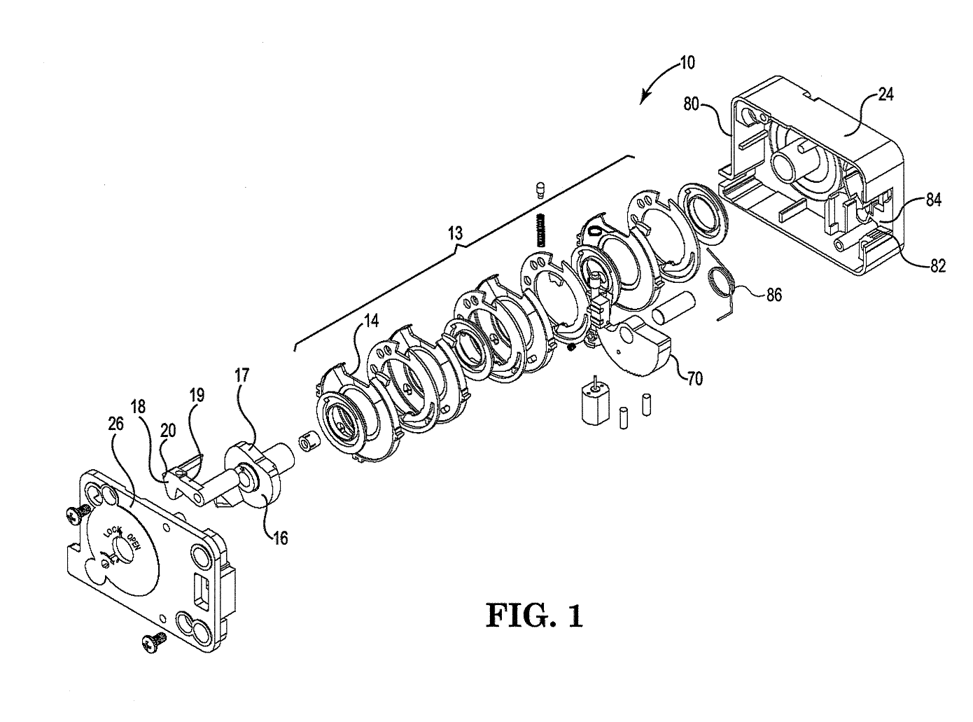

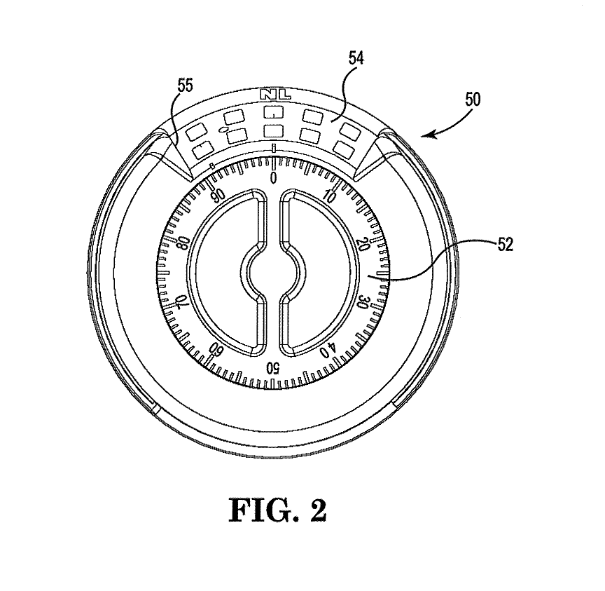

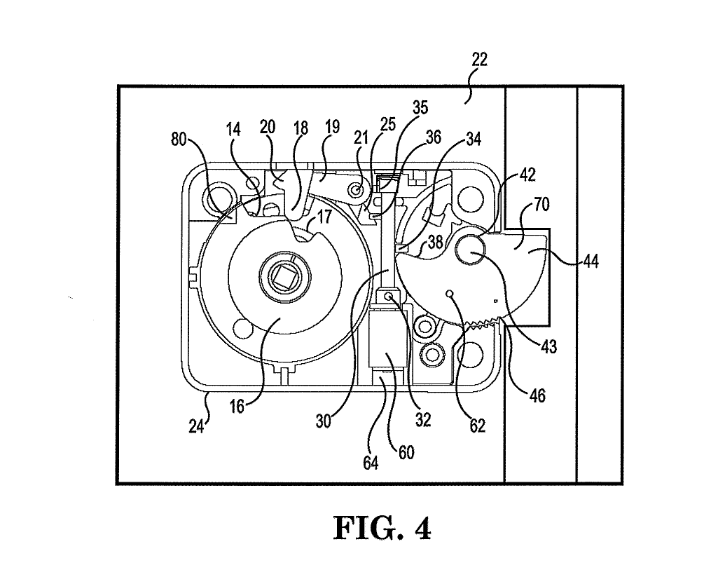

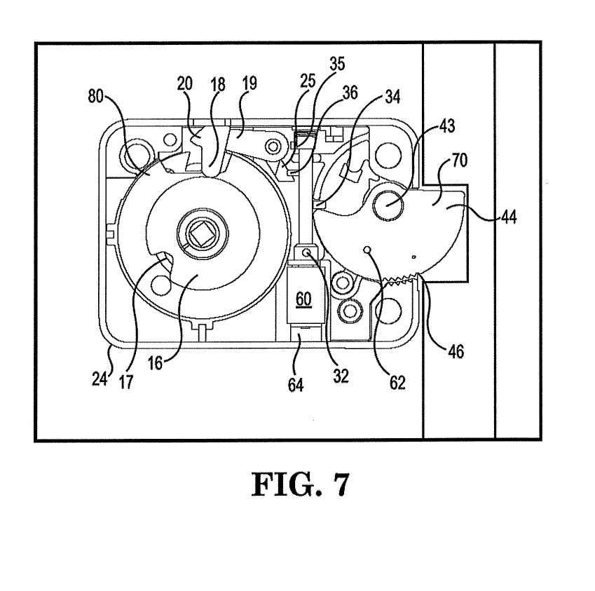

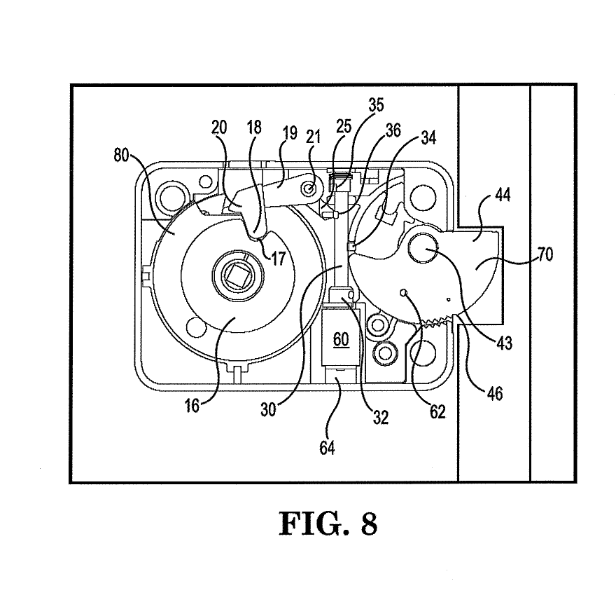

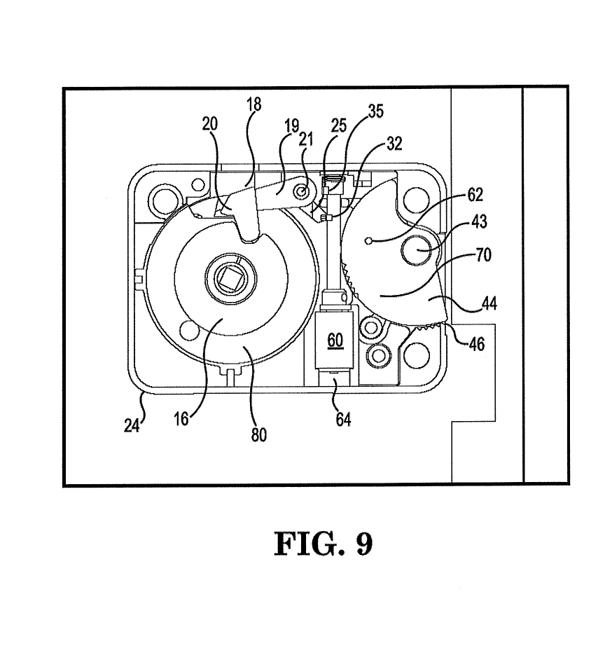

Referring now to FIG. 1 the electronic and mechanical combination lock 10 in accordance with the invention is shown. The electronic and mechanical combination lock is mounted to a wall 22 (as best seen in FIGS. 4-9) which is representative of the door of a container, a safe or security room, or portions of a wall adjacent to such doors. A dual input dial, as best seen in FIG. 2, is mounted on a forward side of the wall 22. The dual input dial is capable of accepting an electronic entry combination or a manual entry combination (i.e. by rotating the dial to the left and right to enter the correct number).

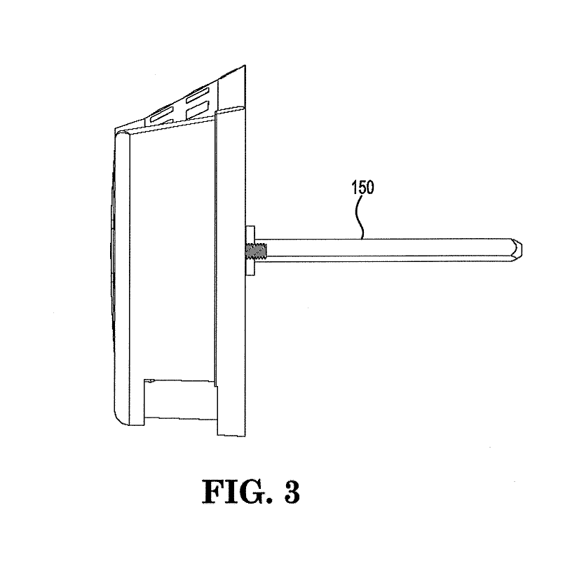

Housing 24 of lock 10 includes faceplate 26 and first and second opposing side walls 80, 82 including opening 84 for receiving a locking bolt 70. In one aspect of the invention, a plurality of gated tumbler wheels 13 each having a gate 14 thereon, are provided within the lock housing 24 in a manner to be manipulated by the manual combination entry dial 52 of dial 50, seen in FIG. 2, via the dial shaft 150 seen in FIG. 3.

A cam wheel 16 which engages with dial shaft 15 is provided with a cam way 17 which receives the nose portion 18 of bolt release lever 19 when the associated fence 20 (best seen in FIGS. 4-9) is received in the aligned gates 14 of the tumbler wheels 13. The bolt release lever 19 is pivotally connected at its second end by pin 21 to housing 24. The second end of bolt release lever 19 includes an locking bar 25 that contacts the second outwardly extending member 36 on the armature post 30 as will hereinafter be described in additional detail below.

Referring now to FIG. 1, a locking bolt 70 mounts in housing 12. In the present embodiment, locking bolt 70 is a rotary bolt having a generally D-shape in cross-section. However, it should be understood that various other shapes of locking bolt 70 are contemplated and within the intended scope of the present invention. A shaft receiving opening 42 is positioned near the center of rotary bolt 70. Shaft receiving opening 42 is configured to receive a shaft or axle that mounts within the housing 24. Shaft 43 mounts in first and second sleeves (not shown) located on the inside walls of housing 24. Shaft receiving opening 42 is generally round and has a diameter that is slightly larger than the diameter of shaft 43. Shaft receiving opening 42 of locking bolt 40 fits onto shaft 43, allowing locking bolt 40 to rotate about the shaft. Thus, a bearing means is formed between opening 42 of locking bolt 40 and shaft 43, which remains generally stationary as locking bolt 40 rotates.

Locking bolt 70 is illustrated in FIG. 4 in a locked position. In the locked position, extended portion 44 of locking bolt 70 extends outside locking bolt opening 46. Locking bolt opening 46 is an indentation in the top wall of housing 24 that is typically formed when the housing is cast. In operation, locking bolt 70 rotates to an unlocked position in which extended portion 44 of locking bolt 70 retracts within housing 24. The movement of locking bolt 70 between the locked and unlocked positions will be described in more detail hereinafter.

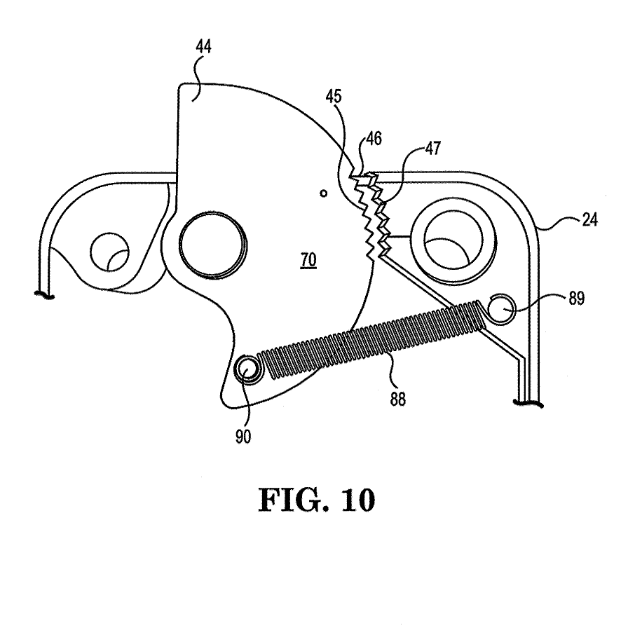

As seen in FIG. 1, a leaf spring 86 is positioned between the bolt and the housing and biases the bolt in the locked position. In an alternative embodiment, as seen in FIG. 10, compression spring 88 stretches from a pin 89 that is located on the inside wall of housing 24 to another pin 90 positioned on the back side of locking bolt 70. In each case, tension from the spring 86, 88 biases locking bolt 70 counterclockwise with extended portion 44 of bolt 70 in the locked position extended outside the housing 24.

As may also be seen in FIG. 10 the locking bolt may include an optional tamper resistant mechanism comprising a plurality of teeth 45 in the locking bolt 70 and a plurality of corresponding teeth 47 in the housing 24. Attempting to forcibly rotate the locking bolt 70 from the locked position, as best seen in FIG. 10, to the unlocked position while the actuator is in the locked condition causes the plurality of teeth on the locking bolt to engage with the teeth 47 in the housing 24 preventing unauthorized entry.

Actuator 60 mounts inside housing 24. Many different types of actuators may be used including, but not limited to, motors, rotary solenoids, electronic and mechanical rotary devices, and electromagnetic rotary devices. For purposes of example, actuator 60 will be described as a rotary solenoid throughout the remainder of this disclosure. Rotary solenoid 60 mounts in a cavity 64 within housing 24, which is formed by several walls extending upward from the inside wall of housing 24. The walls forming cavity 64 are typically part of the casting that forms housing 24. Attached to rotary solenoid 60 via a rotary shaft is an armature post 30.

Armature post 30 includes first 32 and second 35 ends thereof. First end 32 is rotatably coupled to rotary solenoid 60. Armature post 30 also includes first and second outwardly extending members 34, 36. In the locked position, first outwardly extending member 34 contacts the lip portion 38 of swing bolt 70 and functions as a stop preventing swing bolt 70 from moving into the unlocked position by retracting into housing 24. The second outwardly extending member 36 is spaced apart from the first outwardly extending member 34 and is in contact with locking bar 25.

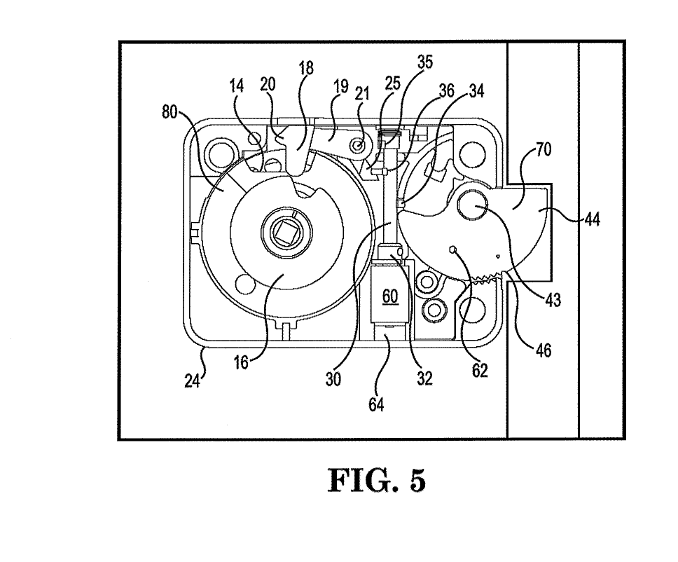

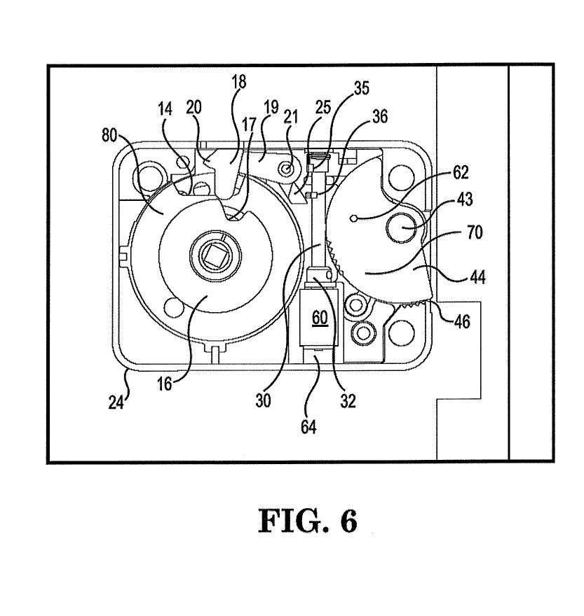

Circuitry within a circuit board (not shown) cooperates with the combination entry device seen in FIG. 2. When the user enters the correct combination on electronic key pad 54, the circuitry signals solenoid 60 to rotate armature post 30 by a predetermined amount. As a result, the armature post 30 rotates by a predetermined amount while first outwardly extending member 34 simultaneously rotates by the same predetermined amount and disengages from lip 38 of locking bolt 70 as best seen in FIG. 5. Second outwardly extending member 34 is stopped by an engaging surface cast in housing 24. As first outwardly extending member 34 disengages from lip 38, locking bolt 70 rotates to the unlocked position by retracting into housing 24 as best seen in FIG. 6.

As noted above, electrical surges in the power line supplying power to the electronic lock can damage the circuitry making impossible the opening of the lock by the authorized user using the electronic key pad 54 of dial 50. In addition, malfunction of the electronic circuitry could also result from tampering, or loss of power making opening of the lock impossible. In such a case the electronic and mechanical combination lock 10 in accordance with the invention includes a mechanically operated locking mechanism 80 operated by the manual combination entry dial 52 of dial 50.

As previously noted, the mechanical locking mechanism a plurality of gated tumbler wheels 13 each having a gate 14 thereon, are provided within the lock housing 24 in a manner to be manipulated by the manual combination entry dial 52 of dial 50, seen in FIG. 2, via the dial shaft 15 seen in FIG. 3.

A cam wheel 16 which engages with dial shaft 15 is provided with a cam way 17 which receives the nose portion 18 of bolt release lever 19 when the associated fence 20 (best seen in FIGS. 4-9) is received in the aligned gates 14 of the tumbler wheels 13. The bolt release lever 19 is pivotally connected at its second end by pin 21 to housing 24.

In operation, a user enters the correction combination by dialing the combination on dial 52. As the correct combination is entered, the plurality of gated tumbler wheels rotate and align. When the associated fence is received in the aligned gates of the tumbler wheel the nose 18 of the bolt release lever 19 is received in the cam way 17. As the nose 18 of the bolt release lever 19 is received in the cam way 17, locking bar 25 of bolt release lever 19 moves downwardly and contacts the second outwardly extending member 36 on the armature post 30 which in turn causes armature post 30 to rotate to the unblocking position. As armature post 30 rotates, the first outwardly extending member 34 rotates behind the lip 38 of the locking bolt. A user turns the handle on the safe door (or other container being secured) which retracts the locking bolt 44 into housing 24.

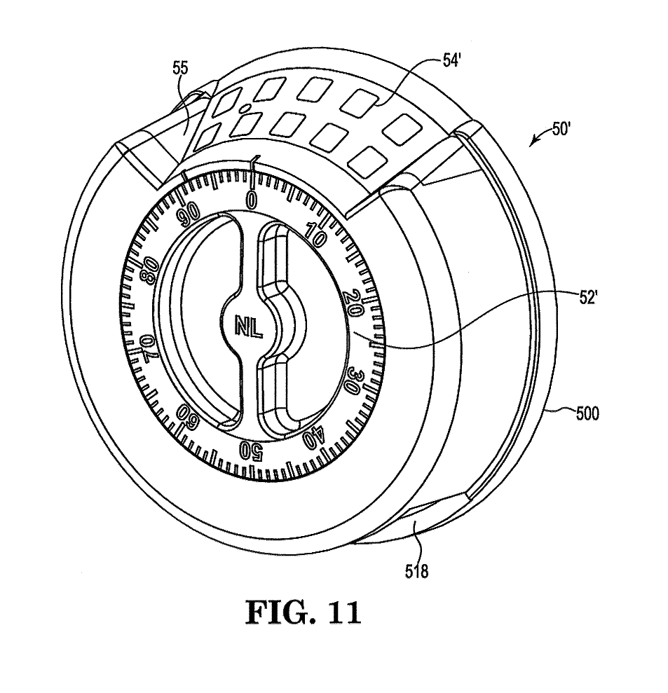

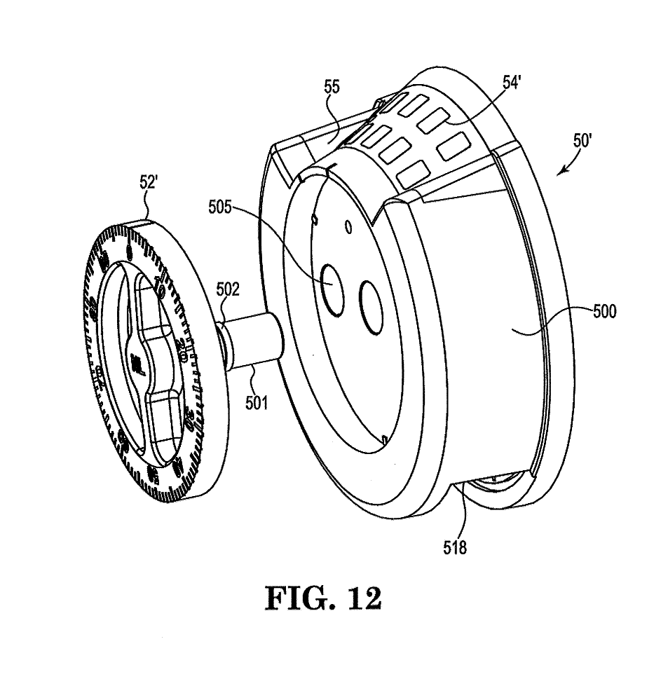

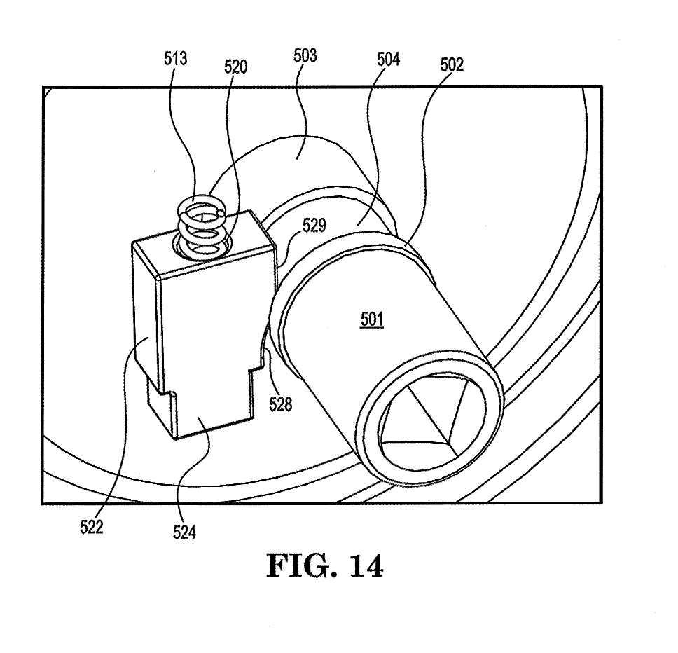

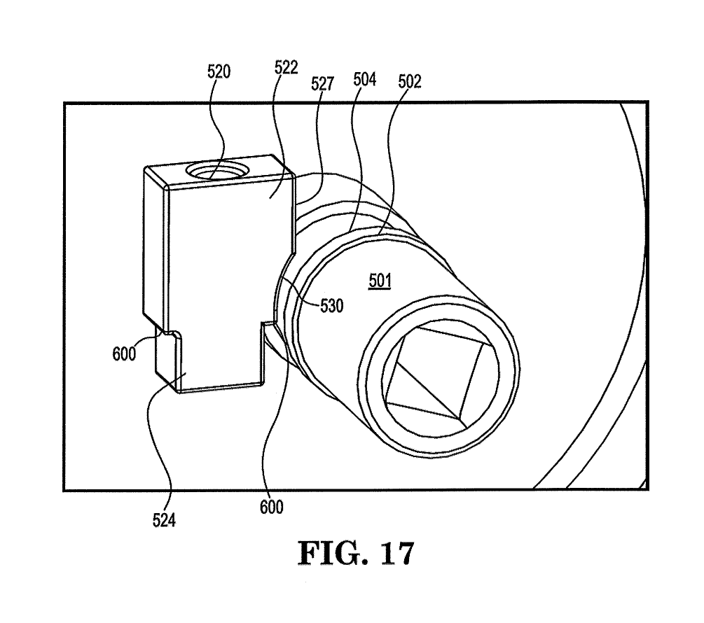

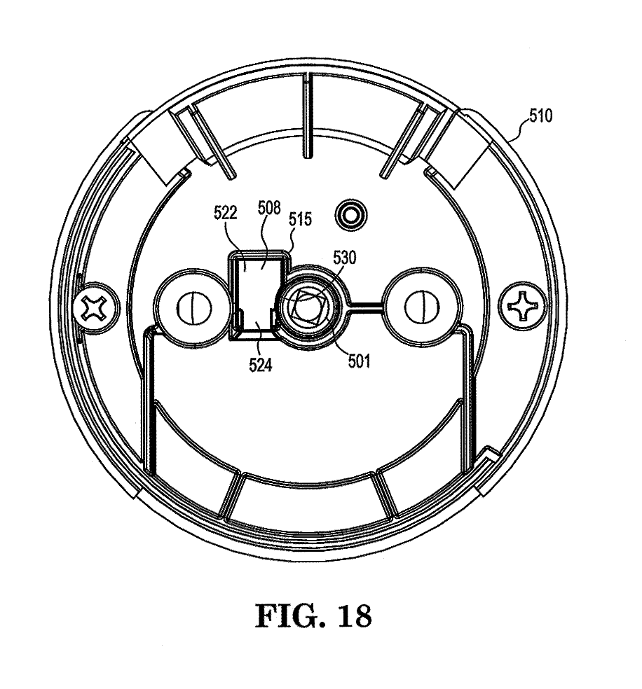

Referring now to FIGS. 11-18 optional locking means for locking and unlocking a removable dial are depicted. Like features are numbered with like reference numerals. Those of skill in the art will appreciate that the removable dial in accordance with the invention may be used with a variety of types of locks and the foregoing disclosure regarding the dual input dial is exemplary only.

FIGS. 11-18 depict a lock having a removable dial. The lock is provided with locking means that are configured to lock and unlock the removable dial. To replace the dial or to service the lock, locking means are provided inside the lock housing. The locking means are moveable between a first locked position and a second unlocked position in which the dial may be removed. The locking means may comprise a finger-actuated button that is biased in the locked position by compression means. The compression means may comprise a spring. Applying force to the button overcomes the counterforce being exerted by the spring and the front facing dial can be easily removed. To replace the dial, force must again be applied to the locking means to move the locking means to the second unlocked position or alternatively the shaft of the dial is inserted into the housing and “snaps” into place.

Dial 50′ includes electronic entry key pad 54′ and manual combination entry dial 52′. The dial 50′ includes a top-reading electronic key pad 54′ configured to be disposed with a recessed portion 55 of the dial housing 500. When the top-reading electronic keypad 54′ is coupled to a container to be secured, the keypad 54′ may be positioned to face upward in a generally horizontal plane relative to the container door, which is in a generally vertical plane, such that a user standing next to the container door is able to look down toward the dial housing and easily view and have access to the keypad. Alternatively, if the dial 50′ is coupled to the container door in a position that is higher than eye level a user can still view the numbers on the key pad 54′ due to the angled positioning of the keypad 54′ into the recessed portion 55.

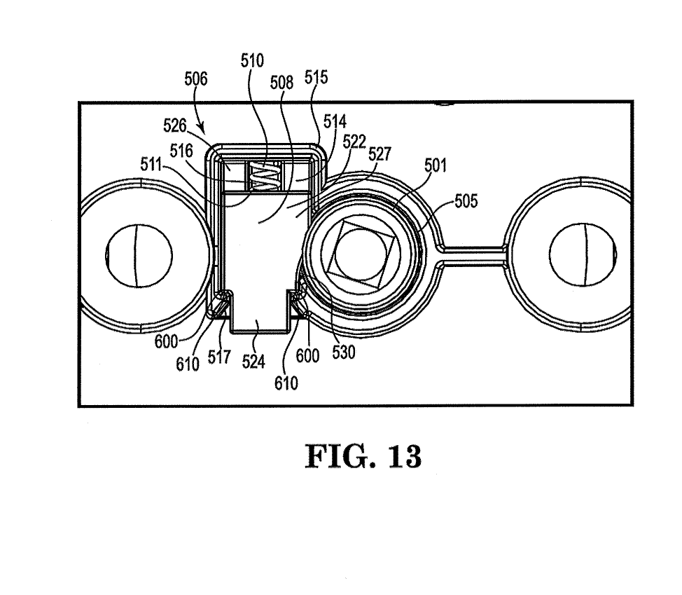

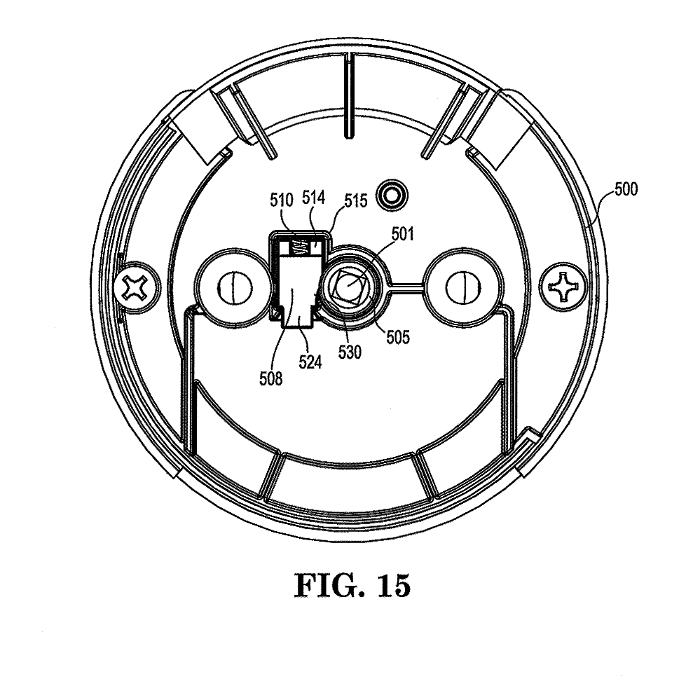

Housing 500 may be constructed from numerous materials. However, the material will typically be a metal, such as brass or stainless steel, but may also be plastic. Removable dial 52′ may be plastic or metal depending on customer preference. Furthermore, the outer surfaces of housing 500 may be chrome-plated or painted, or the unplated metal surface can be polished or brushed for aesthetics. Casting may be a preferred way of forming the housing 512. As best seen in FIGS. 13 and 15 a plurality of cast walls, such as 515, and recesses, such as 514, 516, are formed in housing 512.

Manual combination entry dial 52′ includes shaft 501. Shaft 501 is received through an aperture 505 in housing 500. Dial 52′ is removable from housing 500 as will hereinafter be described. Shaft 501 includes raised ridge 502 circumferentially surrounding shaft 500. End portion 503 of shaft lies adjacent the back face of dial 52′. Recessed shaft portion 504 is formed by raised ridge 502 and end portion 503 and circumferentially surrounds shaft 500.

Locking means 506 broadly includes finger-pressable or finger-actuated button 508 and compression means 510. Compression means 510 are depicted as being an exemplary compression spring but those of skill in the art will appreciate that compression means may include any means that bias the finger-pressable button in the locked position including scissor mechanisms, bellows and the like. Compression means 510 includes first 511 and second 513 ends. An aperture 520 in finger-pressable button 508 receives first end of compression means 510. Second end 513 of compression means 510 abuts wall 514 of recess 514 thereby biasing finger-pressable button 508 in the locked position. Compression means 510 are positioned in recess 516 cast in housing 500. Recess 516 is positioned lower in housing 500 than upper recess 514 also cast in housing 500 and, therefore, upper recess 514 defines and surrounds lower recess 516.

Finger-pressable button 508 is slidingly received within upper recess 514. Finger pressable button 508 includes a first portion 522 that has a width that is greater than a second portion 524 thereof. Upper recess 514 includes a first end 526 that receives the first portion 522 of finger-pressable button and a second end 517 defining an opening through which second portion 524 of finger pressable button 508 slidingly projects. Second portion 524 includes two locking edges 600 which abut housing edges 610 and prevent finger-pressable button from exiting recess 514 due to the force exerted by compression means 510. In use, a user's finger enters housing opening 518 and can easily locate the projected second portion 524 of finger pressable button 508.

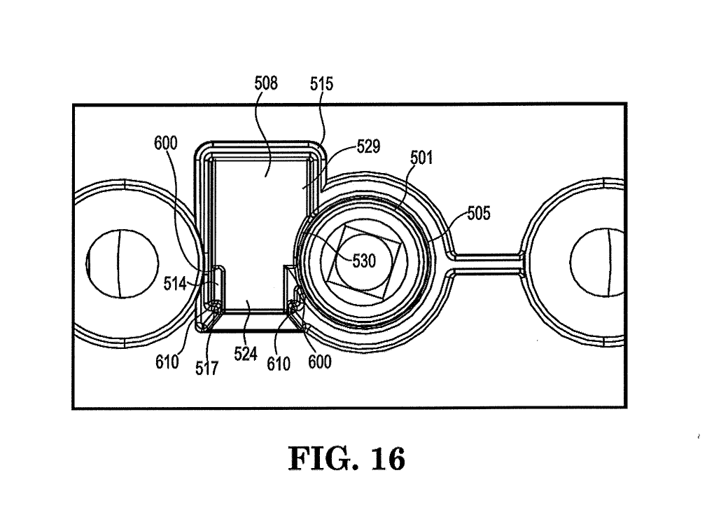

Finger-pressable button 5508 includes a curved surface 528 and a straight surface 529 on a same side of finger-pressable button 508. Curved surface 528 reduces the diameter of first portion 522 of finger-pressable button and matingly engages recessed shaft portion 504 in the locked position. The mating engagement of curved surface 528 and recessed shaft portion prevents the shaft 501 from being removed from shaft opening 505 due to blocking by raised portion 502 as best seen in FIGS. 13-15. Finger-pressable button 508 is accessed by a user through housing opening 518. In operation, when finger-pressable button is pressed by a user, curved portion 528 moves out of engagement with recessed shaft portion 504 thereby allowing raised ridge 502 to by-pass curved portion 528 and finger pressable button 510, which in turn allows the shaft 501 and dial 52′ to be removed from housing 500 as best seen in FIGS. 16-18.

Although the present invention has been described with reference to various aspects of the invention, those of ordinary skill in the art will recognize that changes may be made in form and detail without departing from the spirit and scope of the invention.

I claim:

1. A lock having a removable dial comprising:
a housing;
a removable dial including a shaft receivable by said housing;
a button slidably received within said housing, said button moveable between a first position and a second position;
compression means operably coupled to said button for biasing said button in the first position.

2. The lock having a removable dial of claim 1 wherein said shaft includes a ridge thereon configured to engage said button to maintain said button in the first position.

3. The lock having a removable dial of claim 2 wherein said button includes a curved by-pass portion configured to allow said ridge to by-pass said button when said button is moved to said second position and remove said dial from said housing.

4. The lock having a removable dial of claim 1 wherein said compression means comprise a compression spring.

5. The lock having a removable dial of claim 1 wherein said housing includes an opening configured to allow a user's finger to access said button.

6. The lock having a removable dial of claim 1 wherein a first end of said compression means is operably received within an aperture in said button.

7. The lock having a removable dial of claim 6 wherein a second end of said compression means is configured to abut a sidewall of said housing to bias said compression means in the first position.

8. The lock having a removable dial of claim 1 wherein said first position is configured to prevent said dial from being removed from said housing and said second position is configured to allow said dial to be removed from said housing.

9. The lock having a removable dial of claim 1 wherein said first position is a locked position and said second position is an unlocked position.

10. The lock having a removable dial of claim 1 wherein said housing includes an electronic entry key pad and a manual combination entry dial.

11. The lock having a removable dial of claim 10 wherein said electronic entry key pad is a top-reading electronic key pad.

12. The lock having a removable dial of claim 1 further comprising a shaft having first and second ends, said first end operably coupled to said dial and said second end removably received by an aperture in said housing.

13. The lock having a removable dial of claim 1 wherein said finger pressable button includes a first portion and a second portion, said second portion having a width that is narrower than the width of said first portion.

14. The lock having a removable dial of claim 13 wherein said narrower width of said second portion is configured to allow a portion of said button to extend into said housing opening to provide accessibility to said button by a user.

15. The lock having a removable dial of claim 14 wherein said second portion includes one or more locking edges in mating engagement with a portion of said housing in said first position.

16. The lock of claim 15 wherein said mating engagement is configured to prevent said button from exiting said housing due to the bias exerted by said compression means.
